(19) United States
(12) Patent Application Publication
(10) Pub. No.: US 2026/0142244 A1
(43) Pub. Date: May 21, 2026

(54) LITHIUM METAL BATTERY ARCHITECTURE

(71) Applicants: Quinn Qiao, Jamesville, NY (US); Sally Mabrouk, Syracuse, NY (US)

(72) Inventors: Quinn Qiao, Jamesville, NY (US); Sally Mabrouk, Syracuse, NY (US)

(21) Appl. No.: 19/122,491

(22) PCT Filed: Oct. 25, 2023
(86) PCT No.: PCT/US2023/035924

§ 371 Date: Apr. 18, 2025

Related U.S. Application Data
(60) Provisional application No. 63/419,456, filed on Oct. 26, 2022.

(51) Int. Cl. H01M 10/42; H01G 11/38; H01G 11/50; H01G 11/56; H01M 4/131; H01M 4/58; H01M 4/62; H01M 10/0525; H01M 10/0565

(52) U.S. Cl. CPC H01M 10/4235; H01G 11/38; H01G 11/50; H01G 11/56; H01M 4/131; H01M 4/5825; H01M 4/623; H01M 4/625; H01M 10/0525; H01M 10/0565; H01M 2300/0082

(57) ABSTRACT

A battery architecture based on the inclusion of a solid polymer electrolyte (SPE) as a safer alternative to that of liquid electrolytes. The construction of the battery enables the battery device to store energy not only electrochemically, but also electrostatically through an electric double-layer capacitance formed by the charge separation on the interface between the electrolyte and electrodes. This architecture allows the storage of additional energy, thus exceeding the theoretical specific capacity of a conventional Li metal battery. An interfacial therapy was modified to improve Li metal stability, and to enhance mass transport at the electrolyte/anode interface.

### CROSS REFERENCE TO RELATED APPLICATION

This application claims priority under relevant portions of 35 USC § 119 and 35 USC § 120 to U.S. Application Ser. No. 63/419,456, entitled LITHIUM METAL BATTERY ARCHITECTURE, filed Oct. 26, 2022. The entire contents of the above-listed application are herein incorporated by reference.

### STATEMENT REGARDING FEDERALLY SPONSORED RESEARCH OR DEVELOPMENT

This invention was made with government support under Award #2052611, sponsored by the National Science Foundation (NSF). The government has certain rights in the invention.

### TECHNOLOGICAL FIELD

This application generally relates to the field of compact power storage systems and more specifically to a design for a lithium metal battery having improved storage capacity.

### TECHNOLOGICAL BACKGROUND

There is an increasing demand of rechargeable batteries having high energy density, long cycle life, and low cost. Due to its ultrahigh theoretical specific capacity (3860 mAh/g), as compared to a graphite anode (372 mAh/g) used in currently dominant lithium-ion batteries (LIBs), lithium metal anodes have been extensively investigated as an ideal anode for next generation rechargeable lithium metal batteries (LMBs). However, many challenges prevent the practical application of lithium metal batteries. First, the extreme reactive nature of lithium towards traditional organic liquid electrolytes leads to continuous electrolyte decomposition resulting in a decrease in coulombic efficiency, an increase in interfacial resistance, and an acceleration of electrolyte depletion. Furthermore and at higher currents, the dendritic growth of lithium can lead to penetration of the charge separator and short circuit of the cell, which may further cause a safety risk due to the flammability of the liquid electrolyte. In this regard, the replacement of flammable organic liquid electrolytes with non-flammable solid-state electrolytes is a promising solution to utilize the high potential of the lithium metal anode.

To that end, LMBs are preferred as a small volume power storage system because of their high energy and power density. LMBs operate longer between charges, while still consuming more power, and also achieve the highest cell voltage. Moreover, the self-discharge rate of LMBs is much lower than any other rechargeable cell, no active maintenance is required, and LMBs do not require priming.

Conventional lithium batteries presently available in the market are based on liquid electrolyte(s), which exhibit a narrow electrochemical window. Additionally, conventional lithium batteries dissolve transition metals from the cathode, and provide poor safety due to the increased potential for leakage, flammability, and explosion. Accordingly, a focus of current research of all battery types is upon the use of solid-state electrolyte(s) in lieu of the traditional liquid electrolyte.

One major problem in lithium batteries is metal dissolution from the positive electrode at high voltages. Unstable LiPF₆ is an essential component to suppress anodic (oxidative) dissolution of an aluminum (Al) current collector because its hydrolysis product of hydrofluoric acid (HF) contributes to an insoluble AlF₃ passivation film. However, the generated HF accelerates the dissolution of transition metals from the active electrode materials, which causes severe capacity decay upon cycling, especially at high voltages and elevated temperatures. The dissolved transition metals deposit upon the surface of the negative electrode, catalyze the reductive decomposition of the electrolyte, and consume the limited lithium reserve in the battery, resulting in thickened and passive solid electrolyte interphase (SEI), that further leads or contributes significantly to capacity loss. In order to suppress aluminum dissolution, an unstable salt is required. However and to suppress transition metal dissolution, use of an unstable salt should be avoided.

Using solid-state electrolytes (SSE) in combination with lithium metal anode and high-voltage cathodes will significantly increase the energy density of the battery, and provide additional safety as well. Solid-state electrolytes are promising technologies in developing next generations of lithium ion/metal batteries (LIBs). Such electrolytes can support longer electrochemical stability and higher sensitivity, thereby enabling high specific capacity, power density, and energy density, and thus increasing battery run times.

Dry polymer electrolyte(s) are inexpensive, safe, and thermally stable as they prevents thermal runaway under high temperature or impact. Dry polymer electrolytes provide good mechanical strength, effectively suppress Li dendrite formation, and a thin film polymer can be fabricated with desirable shapes easily. Application of solid polymer electrolytes in batteries was proposed in 1978, five years after P. J. Wright's discovery of ionic conductivity in alkali metal and salt complexes of poly(ethylene oxide) (PEO) in 1973. Since that time, organic solid polymer electrolytes (SPEs) have attracted significant attraction due to easier synthesis, excellent flexibility, better interfacial contact with electrodes, and suitable mechanical properties. Due to the outstanding solubility of lithium salts, PEO has been the most extensively studied polymer matrix to date. However, the high degree of crystallization of PEO limits the ionic conductivity at room temperature and this electrolyte fails to exhibit suitable lithium conductivity unless working at high temperatures. High temperatures will, however, decrease mechanical performance, which is not ideal for real or practical applications. Poly (vinylidiene fluoride, or PVDF), along with its copolymers PVDF-co-trifluoroethylene (PVDF-TrFe), poly (vinylidiene fluoride-cochlorotrifluoroethylene) (PVDF-CTFE), and PVDF-co-hexafluoropropane (PVDF-HFP), are exceptional polymer matrices that stand out for their high polarity, excellent thermal and mechanical properties, chemical inertness, and stability in cathodic environments.

Because of its low degree of crystallinity, which enables improved ionic conductivity, PVDF-HFP is an ideal polymer matrix for SPEs, when compared to other PVDF polymers. Moreover, PVDF-HFP exhibits superior mechanical qualities, a high dielectric constant (between 7 and 9) and highly polar functional groups (—C—F). Many efforts have been performed in order to improve the specific capacity of lithium batteries based on dry solid polymer electrolyte within the last few years. However, these efforts have failed to provide any truly significant change. More specifically, the highest specific capacity achieved to date was 174 mAh/g at a rating of 0.5 C, which is not sufficient to obtain a suitable high energy density solid-state lithium ion/metal battery.

The reason of these drawbacks for lithium batteries that are based on a solid polymer electrolyte (SPE) is that this electrolyte has insufficient stability, since SPEs are not compatible with the lithium metal anode. This incompatability further leads to undesired side reactions, creation of passivation layers, high interfacial impedance, and electrical shorting. Also, slow electron transfer during lithium stripping results in voids at the lithium surface, while uneven lithium deposition results in dendrite growth. The rough contact between the solid electrolyte and lithium metal causes lithium creep resulting in volume changes on a lithium metal surface. Lithium insertion in the cathode leads to volume change on the cathode surface. Such volume changes at the electrodes result in stresses at the electrolyte/electrode interfaces, thus causing SPE degradation. In addition, limited mass transport of the electrolytes results in other deleterious effects that include concentration gradient, passivation layers, ohmic voltage drop, and capacity fading.

### BRIEF DESCRIPTION

The present invention is a novel lithium metal battery architecture that uses a solid polymer electrolyte as a safe alternative to traditional liquid electrolytes, enabling a battery device employing the novel architecture to store energy not only electrochemically, but also electrostatically, through an electric double-layer capacitance formed by the charge separation on the interface between the electrodes and electrolyte. The present invention allows for the storing of additional energy beyond the theoretical specific capacity of a standard lithium metal battery. The present invention also includes the use of an interfacial therapy to improve lithium metal stability, and further to enhance mass transport at the electrolyte/anode interface.

More specifically and according to at least one aspect, the present invention employs a super concentrated stable lithium salt LiN(SO₂F)₂ in the electrolyte with extremely high concentrations that can enhance the coordination to Li+ cations. This combination of salt in the electrolyte inhibits the dissolution of both aluminum and transition metal at around 5V, and realizes a high-voltage lithium-ion battery that exhibits excellent cycling durability, high rate capability and enhanced safety. The high concentration (10 M) of Li bis(fluorosulfonyl)imide (LiTFSI) in the electrolyte interphases of high fluorine content on both Li-metal anode and cathode surfaces. Such fluorine-rich interphases effectively suppress lithium dendrite formation and stabilize the carbonate molecules against oxidation at high cutoff voltages of 4.6 V on the surface of the cathode, enabling high-energy lithium metal batteries (LMBs) having high operation voltage of 4.6 V, high loading of 2.5 mAh/cm², and 86% capacity retention after 100 cycles.

In accordance with aspects of the present invention, a PVDF-HFP/LiTFSI/SN polymer membrane is prepared using Polyvinylidene fluoride-hexafluoropropylene (PVDF-HFP), which is preferred since this material has a relatively high dielectric constant and possesses good mechanical strength. PVDF-HFP has the most potential matrix as a separator because of its low crystallinity (copolymerization effect), at which the amorphous HFP facilitates the ionic conduction and the crystalline VDF acts as a mechanical support for the prepared membrane. Solidifying highly dissociable molten salts in high concentration with polymers (polymer-in salt) improves the performance of the dry solid polymer electrolyte (SPE), such as Li[N(CF₃SO₂)₂] (LiTFSI) and imide salt has good electrochemical/thermal/chemical stability. Li-salt concentration should be optimized so that rough films are not produced. Succinonitrile (SN) improves the SPE ionic conductivity and suppresses aluminum corrosion, since the strengthened combination between SN molecules and Li⁺ cations in the electrolyte restrain the coordination of Al³⁺ to SN molecules.

According to at least one version, there is provided a novel solid polymer electrolyte (SPE) modification for the solid-state lithium metal battery via a drop casting technique to prepare circular discs of SPE. These discs are implemented to assemble Li/Li coin cells and Li/LFP full cells to improve the electrochemical stability and enhance additional energy electrostatically in addition to the electrochemical energy storage of the common battery. This is achieved by adding a small amount of tetrabutylammonium-hexafluorophosphate (TBA-HFP) in the solid polymer electrolyte, which enhances charge separation at the various electrolyte/electrode interfaces. In at least one version, three (3) percent TBA-HFP is used as an additive. According to at one aspect, the invention further can preferably include an interfacial therapy modifier by adding Vanillin at the anode/electrolyte interface to enable a homogenous and intimate physical contact between the SPE and the lithium metal anode. In at least one version, 2 ml/mg of Vanillin is used as the additive amount. The modifications of TBA-HFP and Vanillin are preferably optimized, thereby resulting in great enhancement in the electrochemical redox properties of the battery device. A modified Li-LFP full cell made in accordance with aspects of the invention demonstrates excellent overall cycling durability and capacity as a result of the enhanced stability, mass transport, and storing of energy not only electrochemically, but also electrostatically.

### BRIEF DESCRIPTION OF THE DRAWINGS

The present invention will now be more fully understood and appreciated from reading the following Detailed Description in conjunction with the accompanying drawings, in which:

FIG. 1 is a thermogram taken of a control (unmodified) solid polymer electrolyte membrane (SPE);

FIG. 2 is a thermogram of an SPE membrane that has been modified with an TBA-HFP additive in accordance with aspects of the present invention;

FIG. 3(a) is a graph of Nyquist plots of the solid polymer electrolyte (SPE) membranes of FIGS. 1 and 2, and in accordance with aspects of the present invention;

FIG. 3(b) is an Arrhenius plot comparing the ionic conductivity of the control SPE membrane and the TBA-HFP modified SPE membrane;

FIG. 4 depicts a linear sweep voltammetry output, depicting an electrochemical voltage window of a Li-LFP battery based on solid polymer electrolyte (SPE) that is doped with TBA-HFP, as compared to a control Li-LFP battery that has not been modified with TBA-HFP;

FIG. 5(a) is cyclic voltammetry output of a control Li-LFP battery with a solid polymer electrolyte (SPE);

FIG. 5(b) is a cyclic voltammetry output of an Li-LFP battery having a solid polymer electrolyte in which the anode and cathode are doped with TBA-HFP;

FIG. 5(c) is a cyclic voltammetry output of an Li-LFP battery having a solid polymer electrolyte, an anode and cathode doped with TBA-HFP, as in FIG. 5(b), and an interfacial therapy having a Vanillin additive at the anode/electrolyte interface;

FIG. 6(a) is a graphical plot depicting critical current density (CCD) for a Li/ITh/SPE-TBAHFP/ITh/Li symmetric cell;

FIG. 6(b) is a graph depicting galvanostatic cycling performance of three (3) Li/SPE/Li symmetric cells, one of which is a control cell (Li/SPE/Li), one of which includes Vanillin as an interfacial therapy between the electrolyte/electrode interfaces (Li/Vanillin/SPE/Vanillin/Li), and one further having the interfacial therapy and TBA-HFP added to the solid polymer electrolyte at 0.05 mAh/cm² in accordance with aspects of the present invention;

FIG. 6(c) is a graph depicting the first few cycles of the cycling test of FIG. 6(b);

FIG. 6(d) is a graph of the cycles at 400-410 hours of the cycling test of FIG. 6(b);

FIG. 6(e) is a graph of the cycles at 850-860 hours of the cycling test of FIG. g (b);

FIG. 7(a) depicts a voltage profile of a control Li-LFP battery based on a solid polymer electrolyte (SPE) as compared with a modified Li-LFP battery in accordance with aspects of the present invention that has been optimized with 3% TBA-HFP in the SPE, 5% TBA-HFP in the cathode, and 2 mg/ml of Vanillin at the anode/SPE interface using 0.25 mm thick lithium chips;

FIG. 7(b) illustrates rate performance of the modified LI-LFP batter of FIG. 7(a);

FIG. 8(a) depicts electrochemical impedance spectroscopy (EIS) measurements between an Li-LFP control battery having an unmodified solid polymer electrolyte and an unmodified interfacial therapy with an Li-LFP battery in accordance with aspects of the present invention and having a solid polymer electrolyte that has been modified with TBA-HFP and having an interfacial therapy that includes Vanillin, the EIS measurements being taken prior to cycling;

FIG. 8(b) depicts electrochemical impedance spectroscopy (EIS) measurements between the Li-LFP control battery and modified Li-LFP batter of FIG. 8(a), the EIS measurements being taken after 120 cycles;

FIG. 9 depicts a schematic of a battery cell, illustrating the weakly coordinating TBA-HFP ions as reoriented under the influence of an applied electric field to corresponding electrodes for a 10% supercapacitor in accordance with aspects of the present invention; and

FIG. 10 is a schematic of Vanillin as adsorbed on the surface of a lithium electrode by coordinating its polar groups with the lithium metal.

### DETAILED DESCRIPTION

Referring to the drawings wherein like numerals refer to like parts throughout, the present invention comprises a lithium metal battery architecture that incorporates Tetrabutylammonium-hexafluorophosphate (TBA-HFP) in the solid polymer-in-salt electrolyte and cathode of a Li metal battery. In at least one version, the present invention further comprises the use of 4-hydroxy 3-methoxybenzaaldehyde (Vanillin) additive in an interfacial therapy as a modifier at the anode/electrolyte interface. The exemplary embodiment describes optimized amounts for purposes of the discussion, but it should be realized that this architecture can employ various combinations.

The present invention may employ a super concentrated stable lithium salt LiN(SO2F)2 in an electrolyte with extremely high concentrations, which can enhance the coordination to Li+ cations, as well as inhibit the dissolution of both aluminum and transition metal at about 5V, and realizes a high-voltage Li-ion battery that exhibits excellent thermal cycling durability, high rate capacity and enhanced safety. The high concentration (10M) of lithium bis(fluorosulfonyl)imide (LiTFSi) in the electrolyte interphases of high fluorine content on both the lithium-metal and cathode surfaces. Such fluorine-rich interphases effectively suppress lithium dentrite formation and stabilize the carbonate molecules against oxidation at high cutoff voltages of 4.6V on the surface of the cathode, enabling high energy lithium-metal batteries with high operational voltage of 4.6V, high loading of 2.5 mAh/cm² and 86% capacity retention after 100 cycles according to at least one exemplary embodiment employing this novel architecture.

A PVDF-HFP/LiTFSI/SN polymer membrane in accordance with at least one aspect of the present invention is prepared using Polyvinylidienefluoride-hexafluoropropylene (PVDF-HFP), which is preferred since this material has a relatively high dielectric constant and possesses good mechanical strength. PVDF-HFP has the most potential matrix as a charge separator due to its low crystallinity (copolymerization effect) at which the amorphous HFP facilitates the ionic conduction and the crystalling VDF acts as a mechanical support for the formed membrane. Solidifying highly dissociable molten salts in high concentration with polymers (polymer-in salt) improves the performance of the dry solid polymer electrolyte (SPE) such as Li[N(CF₃SO₂)₂] (LiTFSI) and imide salt has good overall electrochemical/thermal/chemical stability. The lithium-salt concentration should preferably be optimized so that rough films are not produced. The further addition of succinonitrile (SN) improves the SPE ionic conductivity and suppresses aluminum and transition metal corrosion since the strengthened connection between the succinonitrile molecules and Li⁺ cations in the electrolyte restrain the coordination of Al³⁺ to succinonitrile molecules.

### Example

### Materials

Lithium iron phosphate (LiFePO₄)
Polyvinylidiene fluoride binder (PVDF)
Poly (vinylidiene fluoride-co-hexafluoropropylene (PVDF-HFP)
Lithium bis(trifluoromethanesulfonyl)imide (LiTFSI)
Succinonitrile (SN)
Tetrabutylammonium-hexafluorophosphate (TBA-HFP)
4-hydroxy-3-methoxybenzaldehyde (Vanillin)
(1M) LiPF₆

In terms of the above materials, lithium iron phosphate (LiFePO4), lithium chips for coin cell materials (φ15.6*T 0.25), CR 2032-coin cell shells both cathode and anode, stainless steel spacers, and springs from Xiamen Tmax Battery Equipment Limited. Polyvinyldiene fluoride binder (PVDF) (average Mw=534,000 by GPC, powder and poly(vinyldiene fluoride-co-hexafluoropropylene) (HVDF-HFP), average Mw 400,000, average Mn 130,000 pellets from Sigma Aldrich, Lithium bis(trifluoromethanesulfonyl)imide (LiTFSI), anhydrous, 99.9% trace metals basis, succuinonitrile (SN) 99%, and Tetrabutylammonium-hexafluorophosphate (TBA-HFP) (98%) from Sigma Aldrich, 4-hydroxy-3-methoxybenzaldehyde (Vanillin), 99% pure, from ACROS Organics, (1M) LiPF₆, copper and aluminum current collectors from MTI Corporation.

### Method

### i) Preparation of Solid Polymer Electrolyte (SPE) Membrane

A solid polymer electrolyte (SPE) membrane(s) was created by mixing an optimized mass ratio of 19% poly (vinylidiene fluoride-co-hexafluoropropylene) (PVDF-HFP) as polymer host, 34% Lithium bis(trifluoromethanesulfonyl)imide (LiTFSI), 44% succinonitrile (SN) and 3% Tetrabutylammonium-hexafluorophosphate (TBA-HFP) in acetone (0.4 gm/ml). The prepared mixture was dissolved at 80° C. for 2 hours and casted on steel blocks and then placed in a vacuum oven to dry at 50° C. for 12 hours. The dried polymer membranes were then peeled from the steel blocks and stored within an argon-filled glove box. For comparison, a solid polymer membrane was also prepared for a control cell by mixing the optimized mass amounts of 20% PVDF-HFP, 35% LiTFSI and 45% succinonitrile (SN) in acetone (0.4 gm/ml).

### ii) Preparation of Interfacial Therapy

An interfacial therapy (ITh) was prepared in accordance with this example by dissolving 2 mg Vanillin in 1 ml of IM LiPF₆ electrolyte solution. The electrolyte solution was dissolved in ethylene carbonate (EC):ethyl methyl carbonate (EMC)=3.7. For comparison, unmodified IM LiPF₆ was used as an interfacial therapy for the control cell.

iii) Solid-State Lithium Symmetrical Cells

Anodes were prepared in accordance with the example from thin lithium-chips having a thickness of 0.25 mm. The chips were polished and cut to a diameter of 12 mm. For analyzing the ionic conductivity and cycling stability of the prepared solid polymer electrolytes, symmetric cells having the following configuration Li/ITh/SPE/ITh/Li were prepared using the solid lithium-chips and 10 μL ITh at each of the SPE/Li interfaces. The symmetric cells were each assembled onto coin cells in an argon-filled glovebox. Control symmetric cells without surface modification (Li/SPE/Li) were also assembled according to this example for comparison with the modified symmetrical cell.

### iv) Hybrid Solid-State Full Cells Assembly

Cathode ink was prepared by mixing an optimized mass ratio of 78% Lithium iron phosphate (LFP) nanocomposite active material, 10% carbon black, 7% Polyvinylidiene fluoride binder (PVDF), and 5% Tetrabutylammonium-hexafluorophosphate (TBA-HFP) in N-methyl pyrrolidone solvent (0.25 gm/ml). The prepared ink was stirred overnight at room temperature, then casted onto an aluminum foil current collector using a doctor-blade method. The prepared LFP-films were then dried for 24 hours at 80° C. under vacuum, then cut into cathodes, each having a diameter of 12 mm. Anodes were prepared from thin lithium-chips having a thickness of 0.25 mm, which were also cut to a diameter of 12 mm. Finally, the full Li-LFP cells were assembled into coins using 10 μL of the modified and unmodified interfacial therapy (ITh) at the respective electrolyte (SPE)/electrode interfaces. The as assembled full cell was sealed in a 2032 coin cell with nickel foam at the top for absorbing excess pressure during crimping and avoiding damage to the solid electrolyte pellet. The assembly of symmetric cells and full cells was done inside an argon-filled glovebox with moisture and O₂ levels <1 ppm.

### v) Characterizations

Differential scanning calorimetry (DSC) was measured using a Q200 DSC system (TA Instruments) to study the thermal properties of the solid polymer electrolyte (SPE). An Ametek VERSASTAT3-200 potentiostat electrochemical workstation was employed for measuring the electrochemical impedance spectroscopy (EIS) of the solid polymer electrolyte (SPE) membrane and the full cell prepared according to the herein described example. EIS measurements enabled calculations of the ionic conductivity of the polymer membrane, as well characterization of the impedance at the electrolyte/electrode interfaces of the full cell. In addition, linear sweep voltammetry (LSV) and cyclic voltammetry (CV) of the full cell were also measured by the Ametek VERSASTAT3-200 potentiostat. Linear sweep voltammetry enabled the calculation of the maximum charging voltage of the full cell battery having the solid polymer electrolyte in addition to determining the voltage range for CV measurement. Cyclic voltammetry was measured in order to study the effect of the solid polymer electrolyte on the redox properties of the battery electrodes. Galvanostatic charge/discharge measurements of the assembled coin cells according to this example were also performed using a LAND CT2001A system. Galvanostatic cycling performance was performed for the Li/ITh/SPE/ITh/Li symmetric cell and the Li/ITh/SPE/ITh/LFP full cell. Cycling test of the symmetric cell allowed the electrochemical stability and sensitivity of the solid polymer electrolyte to be studied, in addition to the stability of the lithium-metal anode. Finally, a cycling test performed on the full cell enabled the effect of all described modifications according to this example on the capacity and energy density of the battery device to be studied.

### vi) Results

First and to understand the effect of the TBA-HFP additive on the thermal properties of the solid polymer electrolyte (SPE), a thermal curve was initially obtained using differential scanning calorimetry (DSC) for the control and modified SPE having 3% TBA-HFP additive. DSC measures the difference in heat flow between the sample and a reference, such that the generated thermal curve provides the thermal properties of the polymer. These properties include the temperatures of the exothermic processes (crystallization, curing and oxidation) and the endothermic processes (melting and evaporation). As noted, DSC was measured using a Q200 DSC system made by TA Instruments. Approximately 5 mg of each sample was sealed in an aluminum pan and heated from ambient temperature to 400° C., then cooled to 20° C., then heated again to 400° C. at a rate of 10° C./min under a 50 ml/min flow rate of nitrogen.

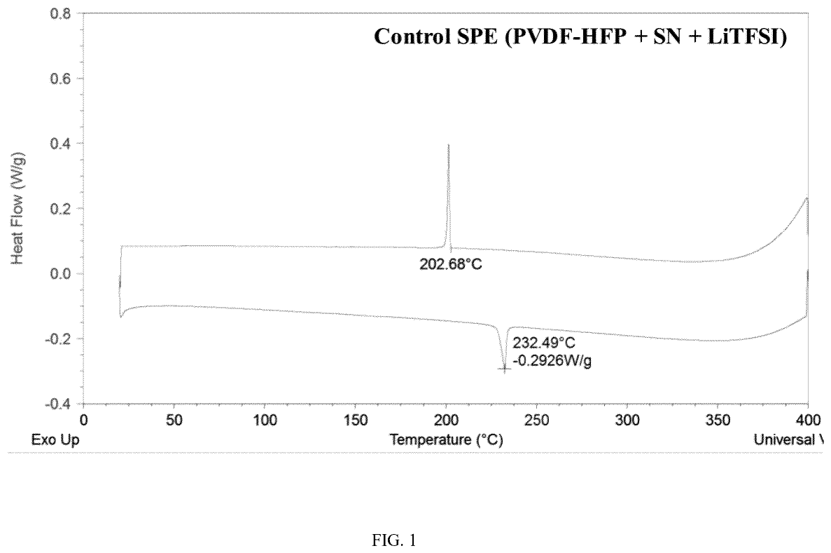

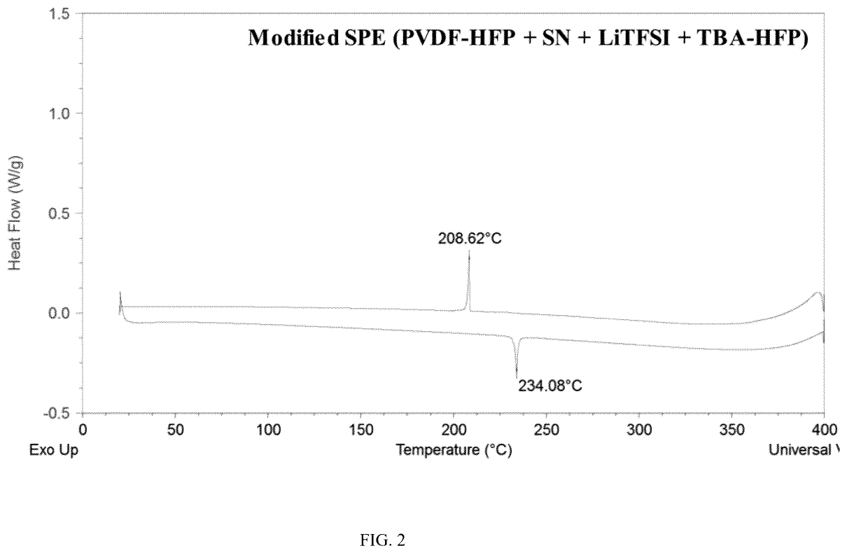

FIGS. 1 and 2 present the DSC thermograms of the control SPE made from 20% PVDF-HFP, 35% LiTFSI, and 44% succinonitrile, and the modified SPE made from 19% PVDF-HCP, 34% LiTFSI, 3% TBA-HFP, and 44% succinonitrile, respectively. These results show an increase in crystallization temperature (Tc) from 202.68 to 208.62° C. and an increase in melting point (Tm) from 232.49 to 234.08° C. as a result of the 3% TBA-HFP additive to the SPE. These results occur because the crystallinity of polymers/copolymers is affected by the presence of salts at which the atoms in the polymer chain are coordinated to the salt, preventing the packing of polymer chains in a crystallite. Thus, SPEs with very high salt concentrations known as polymer-in-salt, have lower crystallinity content (the crystallinity being almost absent) as compared to that of the pure polymer/copolymer. In addition, the addition of salts results in an increase in glass transition (Tg), crystallization (Tc) and melting (Tm) temperatures as a result of the coordination of the salt ions to the polymer atoms, which therefore restricts chain mobility in the amorphous phase. The foregoing explains the increases of Tm and Tc after adding TBA-HFP in the solid polymer electrolyte (SPE).

Mass transport (ion transport) in polymer electrolytes depends on the polymer's morphology, temperature and dielectric constant. Below the melting point of the polymer, crystalline fraction prevents segmental motion (movement of small chain segments). The polymer host folds to form cylindrical tunnels, creating channels through which generated cations can transport. The cations coordinate with the polar groups in the host polymer and transport by dissociation and re-coordination between the neighboring polar groups. Above the melting point, conductivity increases because of segmental mobility at which crystalline regions are completely absent since energy is large enough to overcome the potential barriers between the sites, such that free volume in the system increases as a result of dynamic segmental motion (polymer expansion/relaxation), enabling ions to more easily move and conductivity to increase. The Arrhenius relationship between ionic conductivity and inverse temperature is non-linear (Vogele Tammanne Fulcher model). At higher temperatures, conductivity increases because of hopping rate at which the increase in conductivity is attributed to the vibrational dynamics of the polymer backbone and side chains. The increase of vibrational amplitude can bring the coordination sites closer together and enable the ions to hop to an empty adjacent site, using less energy. As soon as the data of temperature and ionic conductivity obeys the Arrhenius relationship, the mechanism of cation transport is the same as that of ionic crystals (ions jump to the nearest vacant site). In addition, the dielectric constant greatly affects polymer conductivity. By increasing temperature, the dielectric constant of the polymer increases, facilitating dipole orientation, such that the degree of dissociation of salt and ion aggregates increase. The foregoing enhances the number of free ions (charge carrier density-CCD) and conductivity.

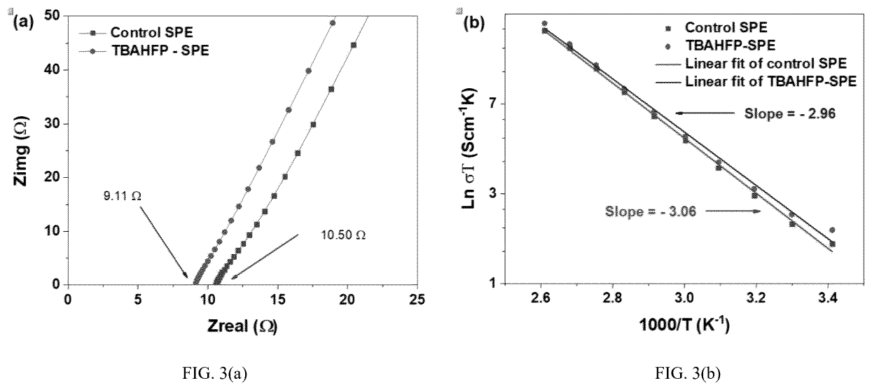

In order to measure the ionic conductivity of the solid polymer electrolyte (SPE), the SPE was sandwiched between two stainless steel plates and assembled into a coin cell. The control SPE and the modified SPE (TBAHFP-SPE) were measured by AC impedance spectroscopy using a Solartron Energy XM Instrument. The temperature range was from room (ambient) temperature to 110° C. at 10° C. intervals, with a fifteen minute soak at each given temperature to allow the sample temperature to stabilize. Measurements were taken over a frequency range from 1 MHz to 0.1 Hz at a fixed amplitude of 10 mV. FIG. 3(a) presents a Nyquist plot of the measured control and TBA-HCP modified solid polymer electrolytes at 20±2° C. The Nyquist plot shows no semicircle, and only capacitive behavior (blocking electrode effect) was observed. It is therefore difficult to distinguish between bulk and grain-boundary components in the depicted Nyquist plots Thus, the total resistance of the solid polymer electrolyte (SPE) membranes was obtained from the intersection of each straight line of the respective plots with the real axis. Electrolyte conductivity was measured using the equation:

$$σ = L / SR$$

in which, R represents the series resistance calculated from the Nyquist plot (10.50 Ohms for the control SPE and 9.11 Ohms for the TBA-HFP SPE), L is the thickness of the SPE (0.10 cm), S is the area of the SPE (1.77 cm²) and σ=ionic conductivity. Ionic conductivity of the modified electrolyte TBAHFP-SPE is 6.20×10⁻³ S/cm as compared to 5.38×10⁻³ S/cm for the control SPE.

The activation energy for conduction was obtained by plotting the ionic conductivity data in the Arrhenius relation for thermally activated conduction using the following equation,

$$σ T = {σ}_{o} exp ( - \frac{{E}_{a}}{kT} )$$

in which Eₐ is the activation energy for conduction, T is the absolute temperature, k is Boltzmann's constant and σₒ is a pre-exponential factor. The equation is linearized by plotting the natural logarithmic of σT and 1000/T (FIG. 3(b)). The calculated activation energy for the modified TBAHFP-SPE electrolyte is 255.1 meV compared to 263.7 meV for the control SPE. The enhancement in ionic conductivity and the decrease in activation energy are attributed to the increase in the dielectric constant of the solid polymer electrolyte after adding TBA-HFP. The weekly coordinating ions of TBA-HFP are re-oriented under the influence of the applied electric field. This reorientation results in electric double-layers formed by the charge separation at the interfaces between the electrolyte and electrodes (higher dielectric constant), thereby producing higher conductivity as well as enhanced mass transport.

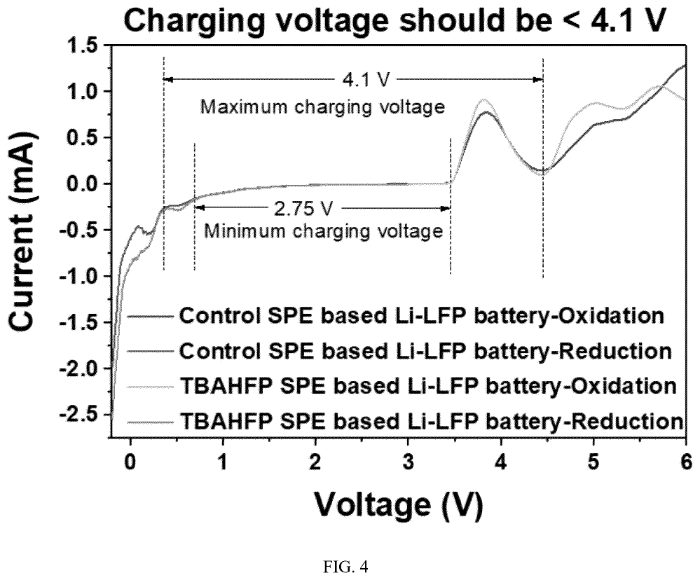

Cyclic voltammetry (CV) and charge/discharge cycling are two (2) important characterizations required for any rechargeable battery. However, the application of high voltage during the aforementioned tests usually results in deterioration of the battery, thus reducing the battery's service lifetime. To select the correct parameters for charge/discharge and cyclic voltammetry tests, linear sweep voltammetry (LSV) of the full cell was measured. Linear sweep voltammetry enables the maximum charging voltage and cyclic voltammetry voltage range of the full cell to be determined. Full batteries based on the control and TBA-HFP modified solid polymer electrolytes as described in the above example were assembled in coin cells and tested for linear sweep voltammetry using the previously described potentiostat. For purposes of these measurements, a positive potential was scanned from Voc to 6.0V and a negative potential was scanned from Voc to −0.2V. FIG. 4 depicts the linear sweep voltammetry measurement, showing the voltage window of the Li-LFP battery based on solid polymer electrolyte (SPE), both before and after doping with TBA-HFP. The results, as shown in FIG. 4, confirm that the presence of TBA-HFP does not substantially affect the voltage window of the battery. The calculated maximum charging voltage 4.0V was selected to be lower than the degradation voltage 4.1V (onset of the degradation peak in the positive scan=4.5 V−onset of the degradation peak in the negative scan=0.4V). The cyclic voltammetry range was determined from the end of the anode reduction peak (0.4V) to the end of the cathode reduction peak (4.4V).

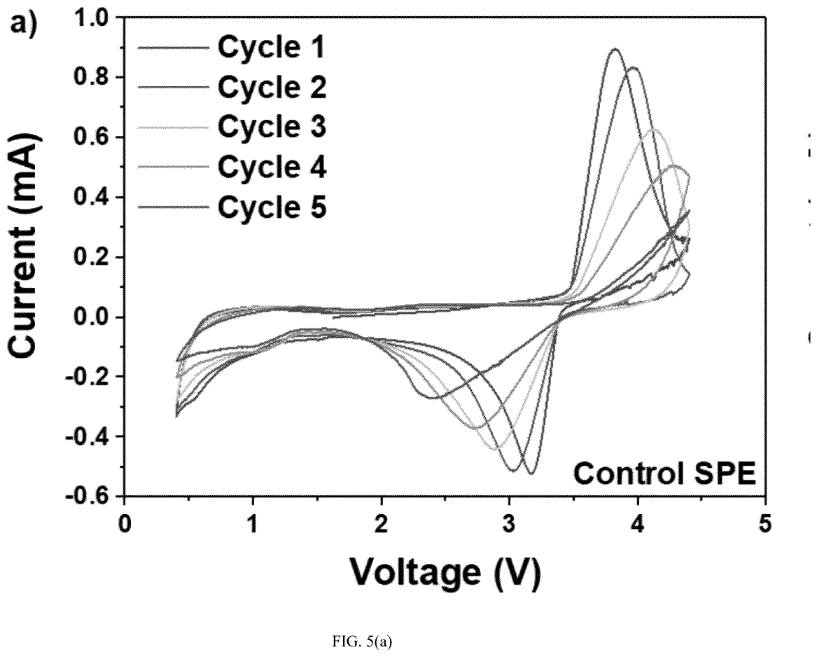

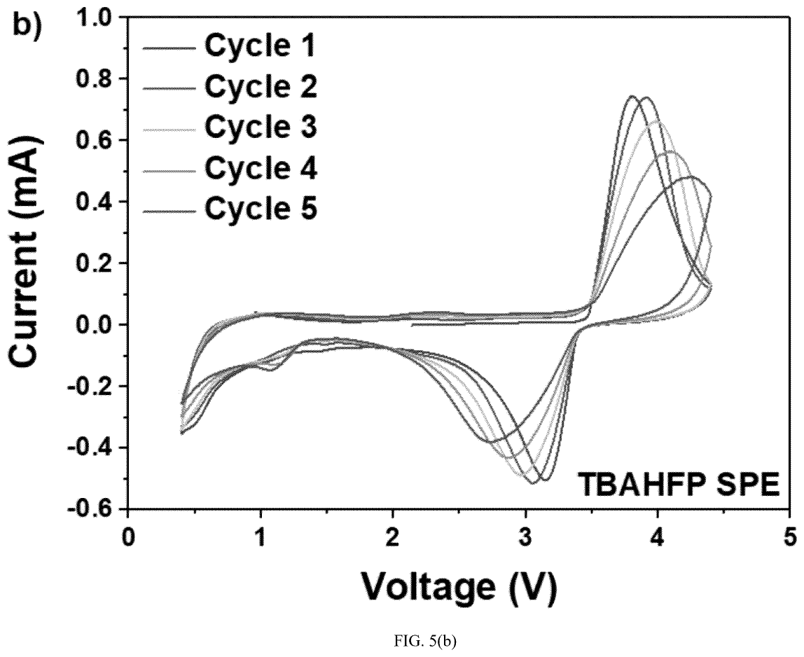

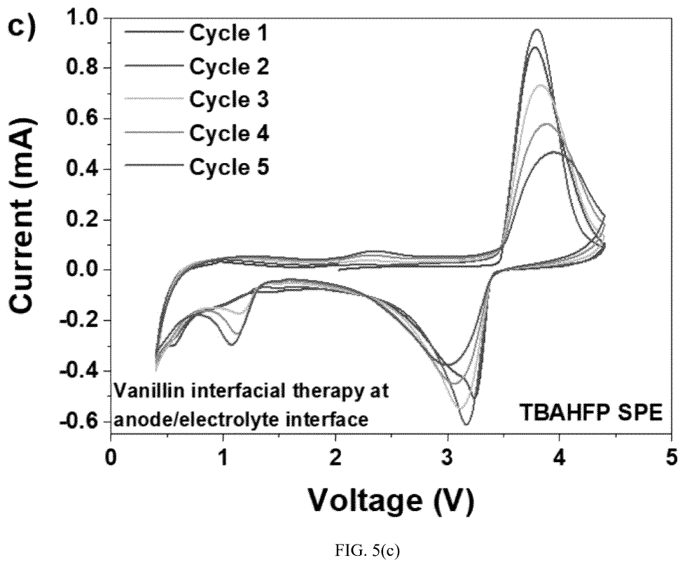

FIGS. 5(a) and 5(b) represent cyclic voltammetry measurements of the Li-LFP battery based on solid polymer electrolyte and made in accordance with the preceding example, taken both before and after doping the polymer and cathode with TBA-HFP, respectively. These measurements were performed up to five (5) cycles in which the scan range was selected from 0.4 V and 4.4 V at a scan rate of 1 mV/sec. The graphical results of these measurements indicate that current peaks decrease by increasing cycle number as a result of degradation of the SPE and cathode, dendrite growth, corrosion, and passivation layers at the electrolyte/electrode interfaces. For the control SPE and as shown in FIG. 5(a), the oxidation peak of the cathode nearly disappeared in cycle five. On the other hand and with reference to FIG. 5(b), the TBA-HFP based SPE did not show any decrease in current for the second cycle compared to the first cycle. Moreover, the TBA-HFP based SPE failed to show any decrease of current peaks while cycling, with cycle 5 clearly indicating an oxidation peak for the cathode. These results confirm that the presence of TBA-HFP improved the electrochemical stability of the SPE.

In cyclic voltammetry, the separation between the reduction and oxidation peaks increases by increasing the scan rate. The foregoing is a kinetic effect, which is caused by the limited speed at which the ions diffuse through the electrode film, needing a long time as compared to the available scan time. The reduction potential from the cyclic voltammetry of the cathode material should equal the phase transition potential at the discharge plateau (the potential at which Li+ cations intercalcate into the LFP cathode). FIGS. 5(a) and 5(b) provide an indication that the oxidation-reduction peak separation increases with cycling, while the phase transition potential shifts to lower values with cycling. Adding TBA-HFP to the solid polymer membrane (SPE) does little to suppress the shift in the oxidation and reduction peaks in addition to the phase transition potential peak.

Further measurements were performed to understand the effect of Vanillin interfacial therapy (ITh) at the anode/electrolyte/and electrolyte/cathode interfaces, as shown in FIG. 5(c). Interestingly, Vanillin enhanced the electrochemical sensitivity and stability of the herein described and exemplary Li-LFP battery. This effect is clearly noticeable from the higher current that is generated after adding Vanillin, in addition to the increase in current for the second cycle as compared to the first cycle. Cycle 5 of the Vanillin-based battery shows more stable and sensitive redox peaks, when compared to the batteries without Vanillin. This latter effect is because the polar groups in Vanillin are able to coordinate with the Li-metal anode surface, protecting that surface from corrosion and dendrite growth and further preventing formation of passivation layers, thus improving overall stability and cycling durability. In addition and perhaps unexpectedly, the interfacial therapy significantly suppresses the shifts in all peaks with cycling including that of cathode oxidation, anode reduction and cathode reduction, and producing more stable charge/discharge voltage while cycling. The stable oxidation-reduction peak separation achieved after using Vanillin is attributed to the polar groups of Vanillin at the electrolyte/cathode interface that coordinate reversibly with the generated Li+ cations, thereby facilitating and speeding up the transport and diffusion of the cations into the cathode (enhanced mass transport).

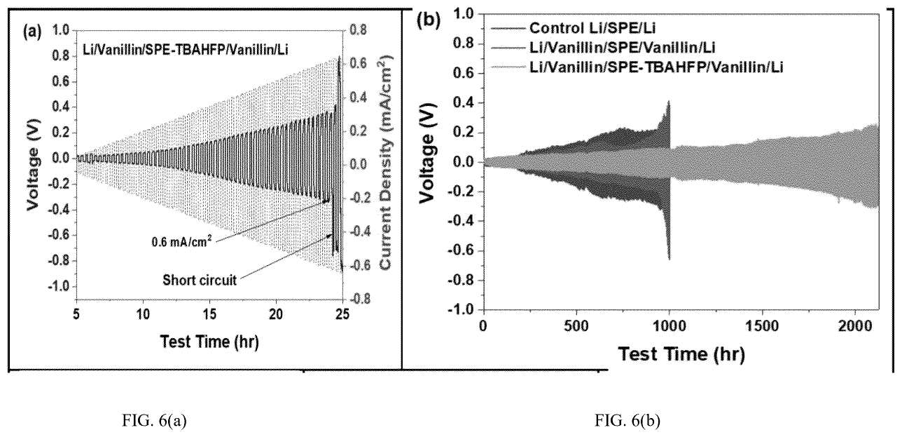

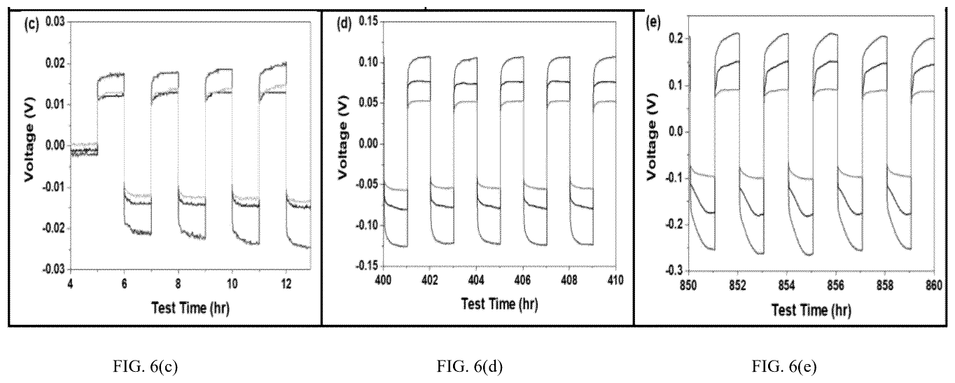

As shown in FIG. 6(a), the critical current density (CCD) of the Li/Vanillin/SPE-TBAHFP/Vanillin/Li symmetric cell was tested and confirmed to be 0.6 mA cm⁻². FIG. 6(b) demonstrates the effect of adding Vanillin in the interfacial therapy (ITh) on the cycling performance of lithium symmetric cells based on SPE. The electrolyte cells were subjected to stripping/plating cycles at a constant current density of 0.05 mA/cm² and a capacity of 0.5 mAh/cm². As further shown in FIG. 6(b), the lithium symmetric cell which is based on the control SPE exhibited large over-potential and hysteresis at which the over-potential started with approximately ±20 mV in the first few cycles and reaching up to ±80 mV after 300 hours. Comparatively, the addition of Vanillin in the interfacial therapy (ITh) decreased the over-potential and hysteresis, in which the over-potential started with approximately ±10 mV in the first few cycles and reaching up to ±60 mV after 300 hours, as shown in FIGS. 6(c), 6(d). The addition of Vanillin to the interfacial therapy (ITh) reduced the energy barrier of the lithium transfer process at the interface, thus facilitating the occurrence of efficient plating/stripping cycles. The foregoing effects are believed to have been realized because Vanillin improves the stability of the lithium metal at which the polar groups in Vanillin coordinate with the lithium metal and deposit on its surface, thus protecting the surface from corrosion and suppressing dendrite growth. In addition, Vanillin polar groups coordinate reversibly with generated Li+ cations. thereby enhancing their mass transport at the interface and within the electrolyte.

FIG. 6(b) also shows the effect of further doping of the SPE with TBA-HFP on the cycling performance of the lithium symmetric cells made in accordance with the foregoing example. The solid electrolyte cells were subjected to stripping/plating cycles at a constant current density of 0.05 mA cm⁻² for 1 hour. TBA-HFP in the solid polymer electrolyte (SPE) decreased the over-potential and hysteresis at which the over-potential after 300 hours decreased from ±60 mV to ±50 mV, as shown in FIGS. 6(b) and 6(c). The weakly coordinating ions of TBA-HFP are reoriented following the applied electric field forming a double electric layer, thus enhancing charge transfer, improving the electrochemical stability of the SPE, and resulting in stable stripping/plating cycling. Vanillin and TBA-HFP provide stable interfaces with low interfacial impedance, suppressed hysteresis and improved cycling durability of lithium metal stripping/plating as a result of the enhanced stability for more than 2000 hours, FIG. 6(b).

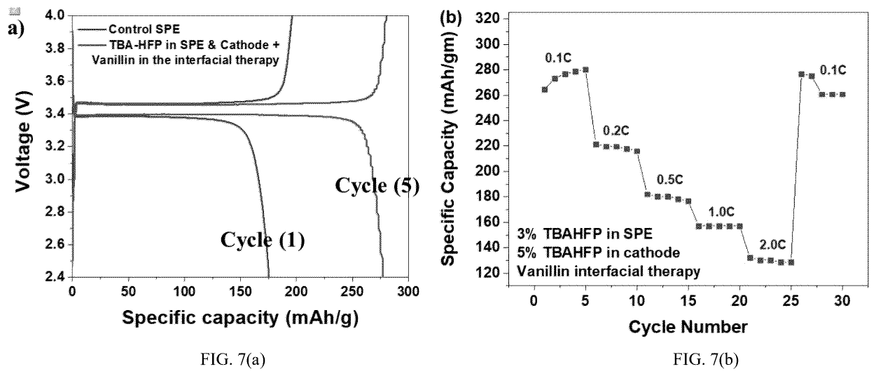

FIG. 7(a) shows a voltage profile of the solid state Li-LFP full cells (control and modified/optimized) assembled using the above-prepared SPE and further using 0.25 mm thick Li-chips. The galvanostatic charge/discharge profile indicates the cycling performance of the cell when cycled at a rate of 0.1C. The graphical results show that adding the optimized concentrations of 3% TBA-HFP in the SPE, 5% TBA-HFP in the cathode, and 2 mg/ml Vanillin in the interfacial therapy at the anode/SPE interface increases the specific capacity of the Li-LFP battery from 175.4 mAh/g (the maximum specific capacity of the control cell cycle #1) to 280.36 mAh/g (the maximum specific capacity of the TBA-HFP and Vanillin based cell cycle #5). The full cell with TBA-HFP SPE and Vanillin interfacial therapy exhibits well-defined and flat voltage plateaus with small polarization of ˜0.05 V, as compared to around 0.1 V for the control cell.

FIG. 7b shows the specific capacity of the optimum Li-LFP full cell at different C-rates. This cell demonstrated good rate capability with discharge capacities of 280.36, 221.43, 182.14, 157.14, and 132.14 mAhg⁻¹ obtained at 0.1, 0.2, 0.5, 1.0, and 2.0 C, respectively. The cell displayed discharge capacity retention of 276.79 mAh/g at 0.1 C, which accounted for 98.73% of the initial capacity after five cycles, each of higher C-rates. These results are in good agreement with the characterization results from the cyclic voltammetry of the full cells and cycling tests of symmetrical cells previously discussed infra. In summary, the foregoing further confirm that TBA-HFP and Vanillin enhanced the electrochemical stability of the SPE and the redox reactions inside the cell, the cycling durability and reversibility of Li stripping/plating and intercalation inside the cathode, and the mass transport to obtain stable and high energy density solid-state Li-metal batteries.

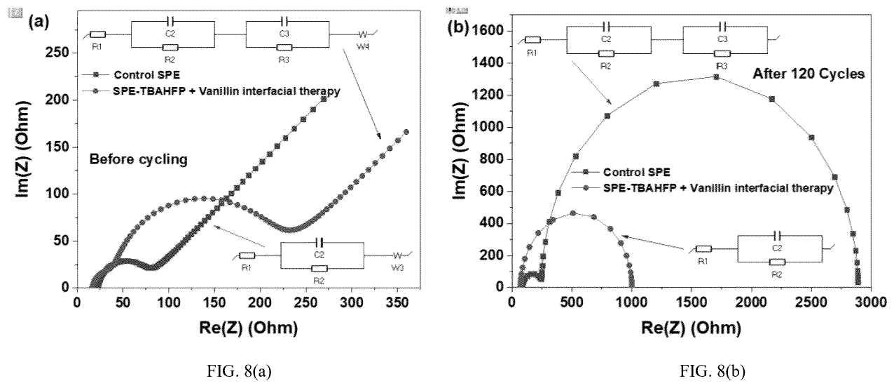

To understand the enhancement in specific capacity, electrochemical impedance spectroscopy (EIS) was measured for the full batteries based on the control and modified SPE, before and after cycling as shown in FIGS. 8(a) and 8(b) and Table 1. More specifically and for purposes of this discussion, FIGS. 8(a) and 8(b) represent EIS measurements of comparing two Li-LFP batteries each based on a solid polymer electrolyte (SPE) before and after 120 cycles. More specifically, a control Li-LFP battery based on unmodified SPE is compared to an optimized Li-LFP battery having both the modified TBAHFP SPE and Vanillin interfacial therapy. Referring first to FIG. 8(a) and before cycling, the Li-LFP battery based on the control SPE shows 21.13 ohm series resistance (R1), as compared to 15.99 ohm for the cell based on TBA-HFP SPE and Vanillin interfacial therapy. After around 120 cycles and with reference to FIG. 8(b), the control SPE based cell exhibited a higher R1 of 82.13 ohm, as compared to 71.58 ohm for the TBAHFP-SPE and Vanillin interfacial therapy based cell. The increase in RI relates to the change in electronic contact, such as the deterioration of the polymeric binder which binds the active materials and the current collector together. This confirms that TBA-HFP improved the electrochemical stability of the SPE and the binder in the cathode material.

As shown in FIG. 8(a) and before cycling, adding Vanillin in the interfacial therapy at the anode/electrolyte interface resulted in 2 semicircles (capacitance-resistance element (CRE)) in the high frequency region (R2) (19.46 and 159.3 ohms), as compared to only one semicircle for the control cell (46.14 ohms) which is attributed to the impedance at the anode/electrolyte interface. The first small semicircle in the Vanillin based cell is because Vanillin enhanced the formation of an artificial solid electrolyte interface (SEI) layer.

After 120 cycles and as shown in FIG. 8(b), a huge (CRE) semicircle appeared in the low frequency region which is attributed to the impedance at the cathode/electrolyte interface (R3). The R2 semicircle is clearly pronounced in the control cell, while it is not clear in the TBA-HFP/Vanillin based cell since it is merged with R3. The inclined-straight line at the low frequency region represents the electrolyte diffusion inside the cathode (Warburg impedance W). In this work, EIS shows Warburg impedance before cycling because of the 10 μL interfacial therapy, however it disappeared after 120 cycles since this therapy dissolved the SPE, providing a gel interface. Results show a significant increase in R2 (163.5 ohms) of the Li-LFP battery based on the control SPE, after cycling. Typically, the increase in R2 corresponds to the change in the morphology of Li surface after the long cycling as a result of corrosion, dendrite growth, and precipitation of irreversible passivation layers on its surface.

With continuous growth of layers, diffusion of Li⁺ cations from the anode into the electrolyte decrease, thus charge transfer resistance increase till the passivation layer become impermeable for Li⁺ ion diffusion resulting in a decline of the oxidation process at the anode. Adding TBA-HFP in the solid polymer electrolyte and Vanillin in the interfacial therapy decreased the impedance, which is in good agreement with cyclic voltammetry and cycling test measurements. This confirms that TBA-HFP improved the electrochemical stability of the SPE blocking its decomposition and precipitation of passivation layers at the electrolyte/electrode interfaces. Vanillin also shared in reducing the impedance because the polar groups in Vanillin coordinate with Li-metal at the anode surface forming a protective layer that reduces corrosion, dendrite growth, and precipitation of passivation layers. In addition, these polar groups are able to reversibly coordinate with the generated Li⁺, thus facilitating their transport from the anode to the solid electrolyte in (Lowering in activation energy of Li⁺ resulted in better mass transport).

With reference to FIG. 8(b), the control cell shows huge R3 (2644 ohms), as compared to (998.7 ohms) for the TBA-HFP/Vanillin based cell. Usually, the increase in R3 is due to the fact that some part of the intercalated electrode does not reverse back when charging. Therefore, the amount of the available site for the intercalation of Li⁺ species is degraded. The irreversible intercalated part had an important role in the increase of R3, resulting in the capacity fading upon cycling.

TABLE 1
EIS parameters of Li-LFP battery based on SPE before and after 120 cycles

| | | | Series | | | | |
|---|---|---|---|---|---|---|---|
| | | | resistance | Anode/SPE interface | | | |
| | | Equivalent circuit | R1 (Ω) | C2 (F) | R2 (Ω) | C3 (F) | R3 (Ω) |
| Before | Control | R1 + C2/R2 + W3 | 21.13 | 2.8E−6 | 46.14 | — | — |
| Cycling | Modified | R1 + C2/R2 + C3/R3 + W4 | 15.99 | 2E−6 | 19.46 | 8.1E−6 | 159.3 |
| After 120 | Control | R1 + C2/R2 + C3/R3 | 82.13 | 0.54E−6 | 163.5 | 19.1E−6 | 2644 |
| Cycles | Modified | R1 + C2/R2 | 71.58 | — | — | 5.53E−6 | 998.7 |

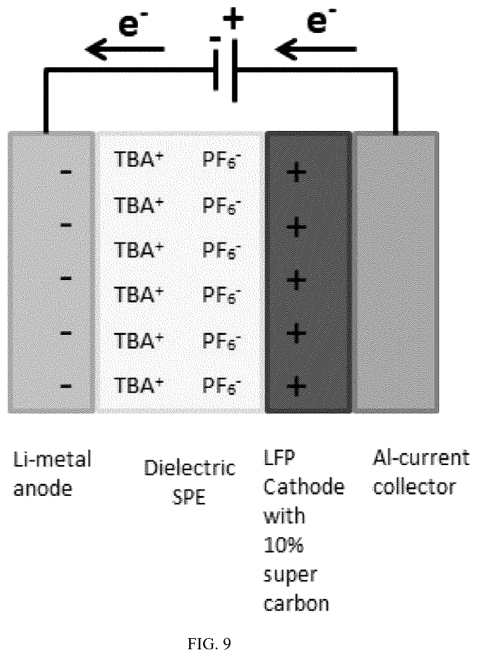

Tetrabutylammonium-hexafluorophosphate (TBA-HFP) is a common material added in the electrolyte of the electrochemical experiments since this material improves the stability and sensitivity of the electrochemical redox reactions. TBA-HFP ions are weakly coordinating, so when TBA-HFP is incorporated in the solid polymer-in-salt electrolyte and cathode of the lithium metal battery, this material acts as a catalyst acting to re-orientate under the influence of the applied electric field to their corresponding electrodes. Separated negative PF₆⁻ ions accumulate at the anode/electrolyte contact, thus assist hole injection to the Li anode and coordinate with Li⁺ cations facilitating their transport within the electrolyte. The positive TBA⁺ ions accumulate near the cathode facilitating electrons injection from the aluminum into the cathode by reducing the tunneling barrier of the cathode interface, as shown in FIG. 9.

The cathode according to this novel architecture is made of a slurry containing not only the active material, but also 10% carbon, thus this architecture not only acts as a lithium metal battery (80%), but also a supercapacitor (10%) at which the lithium metal and carbon are the anode and cathode of the supercapacitor, respectively. This novel supercapacitor structure allows storage of the electrical energy through the electric double-layer capacitance formed by the charge separation at the interface between the electrolyte and electrodes. This allows the battery device to achieve beyond the theoretical specific capacity via charging the supercapacitor, while charging the lithium metal battery. This mechanism is achievable in case of using thin lithium metal anode to not exceed the diffusion length of charge carriers and enable extraction of all the generated carriers from the external circuit.

FIG. 9 is a schematic shows the working principal of storing the potential energy electrostatically within the 10% Li-carbon supercapacitor (supercapacitor charging). The solid polymer electrolyte (SPE) is the dielectric/insulator between the supercapacitor plates to separate the collection of positive (+ve) and negative (−ve) charges building on each side's plates. It is this separation that allows the device to capture static electricity and store energy during the Li-metal battery charging and release it (supercapacitor discharging) during the battery discharging.

To achieve better and close contact between the electrodes and the solid electrolyte and minimize the interfacial impedance, an interfacial electrolyte therapy was introduced at each of the anode/electrolyte and cathode/electrolyte interfaces. This interfacial therapy contain Li-salt and able to slightly dissolve the solid polymer electrolyte only at the interface. The reason why this modified interfacial therapy helps in formation of an artificial SEI layer at the anode/electrolyte interface and soften the solid electrolyte at the interface, thus prevent the tough contact with lithium metal, protecting it from creep. In addition, the softened solid electrolyte at the cathode/electrolyte interface was able to penetrate and diffuse inside the cathode for better contact and higher electrochemical performance.

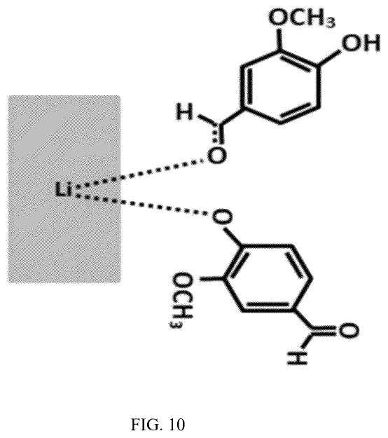

As discussed herein, a new additive “Vanillin” was added in the interfacial therapy at the anode/electrolyte. Vanillin material on top of the lithium metal suppresses lithium side reactions, dendrite growth and volume changes during cycling, thus provides new approaches to solve the challenges of the interface instability in lithium metal batteries. Vanillin (4-Hydroxy-3-methoxybenzaldehyde) has been proved as an effective additive in the zinc battery electrolyte to prevent dendrite growth. This new interfacial layer was adsorbed on the surface of Li electrode by coordinating its polar groups with the lithium metal, thus preventing the formation of dendrites, and acting as passivation layers to slowdown other side reactions. FIG. 10 schematically demonstrates the mechanism how Vanillin forms bonds with lithium metal in the anode/electrolyte interfacial layer.

In summary, a solid polymer electrolyte (SPE) based battery is a safe alternative to that based on liquid electrolyte, the latter of which suffers from high impedance and capacity fading. To overcome the drawbacks of SPE based Li-metal battery, a novel construction has now been designed to enable the battery device to store energy electrostatically in addition to the electrochemical storage. This construction enable the device to exceed the theoretical specific capacity of the conventional Li metal battery. More specifically and to achieve this result, a very small amount of tetrabutylammonium-hexafluorophosphate was added in the solid polymer electrolyte, which resulted in electric double-layer capacitance formed by the charge separation at the interface between the electrolyte and electrodes. In accordance with an exemplary embodiment, ionic conductivity was 6.20×10⁻³ S/cm and the activation energy for Li⁺ migration was 255.1 meV. Symmetrical cell results show that the SPE obtained was stable for more than 2000 hours without significant increase in over-potential. The invention/architecture further describes an interfacial therapy modifier by adding Vanillin at the anode/electrolyte interface. This modifier improved the electrochemical stability and cycling durability of the lithium metal battery, minimized impedance, and enhanced mass transport. TBA-HFP ions in the solid polymer electrolyte re-orientate under the influence of the applied electric field and accumulate on their corresponding electrodes facilitating carriers' injection into the electrodes. The new additive “Vanillin” in the interfacial therapy at the anode/electrolyte interface suppressed side reactions, dendrite growth and volume changes during cycling, as a result of its adsorption on the surface of Li electrode by coordination via its polar groups with the Li metal. An optimum cell with 3% TBA-HFP in the SPE, 5% TBA-HFP in the cathode, and 2 mg/ml Vanillin in the interfacial therapy demonstrated good rate capability with discharge capacities of 280.36, 221.43, 182.14, 157.14, and 132.14 mAhg⁻¹ obtained at 0.1, 0.2, 0.5, 1.0, and 2.0C, respectively. The cell displayed discharge capacity retention of 276.79 mAhg⁻¹ at 0.1C which accounted for 98.73% of the initial capacity after five cycles each of higher C-rates. This concludes that this work provides a new solution to the development of Lithium metal batteries using solid polymer electrolytes.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C.

This detailed description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above and as set forth in the following appended claims.

1. A lithium metal battery comprising:
an anode formed from an amount of lithium metal;
a cathode formed from a lithium iron phosphate nanocomposite, carbon black, and a polyvinylidiene fluoride binder; and
a solid polymer electrolyte membrane comprising polyvinylidene fluoride-hexafluoropropylene (PVDF-HFP) and tetrabutylammonium-hexafluorophosphate (TBA-HFP).

2. The lithium metal battery according to claim 1, further comprising an interfacial therapy, including 4-hydroxy-3-methoxybenzaldehyde (Vanillin) at an interface between the solid polymer electrolyte membrane and the anode.

3. The lithium metal battery according to claim 2, further comprising the interfacial therapy including Vanillin at the interface between the cathode and the solid polymer electrolyte membrane.

4. The lithium metal battery according to claim 1, wherein the solid polymer electrolyte membrane further includes a stable lithium salt having a concentration of 10M or above.

5. The lithium metal battery according to claim 4, wherein the lithium salt is 10M lithium bis(fluorosulfonyl)imide (LiTFSI).

6. The lithium metal battery according to claim 4, wherein the solid polymer electrolyte membrane further comprises succinonitrile.

7. The lithium metal battery according to claim 3, wherein the solid polymer electrolyte membrane includes 3% TBA-HFP by weight.

8. The lithium metal battery according to claim 1, wherein the cathode further comprises an amount of TBA-HFP.

9. The lithium metal battery according to claim 7, wherein the solid polymer electrolyte membrane further comprises 2 ml/mg of Vanillin.

10. The lithium metal battery according to claim 1, wherein the battery further acts as a supercapacitor.

11. A lithium metal battery comprising:
an anode formed from an amount of lithium metal;
a cathode formed from a lithium iron phosphate nanocomposite, carbon black, and a polyvinylidene fluoride binder;
a solid polymer electrolyte membrane including polyvinylidene fluoride-hexafluoropropylene (PVDF-HFP) and tetrabutylammonium-hexafluorophosphate (TBA-HFP); and
an interfacial therapy added at least between the anode and the solid polymer electrolyte membrane, the interfacial therapy comprising 4-hydroxy-3-methoxybenzaldehyde (Vanillin).

12. The lithium metal battery according to claim 11, wherein the interfacial therapy is further added between the solid polymer electrolyte membrane and the cathode.

13. The lithium metal battery according to claim 11, wherein the solid polymer electrolyte membrane further comprises a stable lithium salt in concentration of 10M or above.

14. The lithium metal battery according to claim 13, wherein the stable lithium salt is 10M lithium bis(fluorosulfonyl)imide (LiTFSI).

15. The lithium metal battery according to claim 13, wherein the solid polymer electrolyte membrane further comprises succinonitrile.

16. The lithium metal battery according to claim 11, wherein the solid polymer electrolyte membrane includes 3% TBA-HFP by weight.

17. The lithium metal battery according to claim 16, wherein the solid polymer electrolyte membrane includes 2 ml/mg of Vanillin.

18. The lithium metal battery according to claim 16, wherein the cathode further includes an amount of TBA-HFP.

19. The lithium metal battery according to claim 11, wherein the battery further acts as a supercapacitor.

20. A method of manufacturing a lithium metal battery comprising an anode formed from a lithium metal, and a cathode, the method comprising:
providing an anode comprising an amount of a lithium metal;
providing a cathode formed from a lithium iron phosphate nanocomposite, carbon black, and a polyvinylidene fluoride binder; and
providing a solid electrolyte membrane comprising polyvinylidene fluoride-hexafluoropropylene (PVDF-HFP) and tetrabutylammonium-hexafluorophosphate (TBA-HFP).

21. The method according to claim 20, further comprising:
providing an interfacial therapy between at least one of the solid electrolyte membrane and the cathode and the anode and the solid electrolyte membrane, the interfacial therapy comprising 4-hydroxy-3-methoxybenzaldehyde (Vanillin).
